(19) United States
(12) Patent Application Publication
(10) Pub. No.: US 2026/0309620 A1
(43) Pub. Date: Oct. 8, 2026

(54) All-Reflective Optical Imaging Spectrometer with Flat Dispersive Element

(71) Applicant: Massachusetts Institute of Technology, Cambridge, MA (US)

(72) Inventor: James Johnson, Reading, MA (US)

(21) Appl. No.: 19/170,753

(22) Filed: Apr. 4, 2025

(51) Int. Cl. G01N 21/31

(52) U.S. Cl. CPC G01N 21/31; G01N 2201/0634; G01N 2201/0635; G01N 2201/0636

(57) ABSTRACT

A slit-based imaging spectrometer that comprises five freeform mirrors provides low keystone distortion and low smile distortion. The spectrometer can have an f-number no larger than 2.2, a slit length of up to 28 mm, and fit within a standard Cubesat volume of 4U or less. The spectrometer can be readily scaled for longer slit lengths and large focal plane array detectors.

### STATEMENT OF GOVERNMENT SUPPORT

This invention was made with government support under FA8702-15-D-0001 awarded by the U.S. Air Force. The government has certain rights in the invention.

### BACKGROUND

Imaging spectrometers resolve both spatial and spectral information onto an imaging plane or focal plane where an electronic imager can be located to capture spatial and spectral information about a scene viewed by the imaging spectrometer. By providing fine enough spectral resolution, the spectrometer with signal-processing apparatus can detect and identify spectral signatures (such as the presence of chemical emissions) of objects viewed within the scene. There currently exist several different designs for imaging spectrometers which include the Offner-Chrisp imaging spectrometer and Dyson imaging spectrometer. Recently, a three-mirror imaging spectrometer that uses freeform mirrors has been described.

### SUMMARY

The present disclosure relates to an imaging, all-reflective spectrometer. The imaging spectrometer comprises five freeform reflective surfaces that permit use of a spectrally-dispersive optical element that is without curvature on its optical surfaces (e.g., a flat or planar grating, a prism with flat surfaces through which optical rays pass or reflect from). The five freeform surfaces provide improved aberration control, allowing the design to correct imaging and spectral aberrations over a wider field while maintaining a low size, weight and power (SWAP) figure of merit. Some implementations of the imaging spectrometer having a fast f-number (f/2.8) can be contained within a 1 U, standard Cubesat volume or unit (which measures 10 cm×10 cm×10 cm). Faster f-numbers are possible for implementations that fit within a 2 U volume. The imaging spectrometer is arranged in a folded, double-pass optical configuration with space to accommodate an electronic imager.

Some implementations relate to an imaging spectrometer comprising: an entrance slit through which radiation enters the imaging spectrometer; a first freeform mirror having positive focal power arranged to receive and reflect the radiation that passed through the entrance slit; a second freeform mirror having positive focal power arranged to receive and reflect the radiation that reflected from the first freeform mirror; a third freeform mirror having negative or positive focal power arranged to receive and reflect the radiation that reflected from the second freeform mirror; a fourth freeform mirror having positive focal power arranged to receive and reflect the radiation that reflected from the third freeform mirror; a fifth freeform mirror having positive focal power arranged to receive and reflect the radiation that reflected from the fourth freeform mirror; a spectrally-dispersive optic arranged to receive, reflect and spectrally disperse the radiation that reflected from the fifth freeform mirror, where radiation reflected from the spectrally-dispersive optic passes back through the imaging spectrometer sequentially reflecting from the fifth freeform mirror, the fourth freeform mirror, the third freeform mirror, the second freeform mirror, and the first freeform mirror; and a detector array arranged to receive the radiation that passed back through the imaging spectrometer and reflected from the first freeform mirror.

Some implementations relate to methods of forming a spectrally-dispersed image. Such methods can comprise acts of: receiving radiation through an entrance slit of an imaging spectrometer; reflecting the radiation that passed through the entrance slit from a first freeform mirror mounted in the imaging spectrometer, the first freeform mirror having positive focal power; reflecting the radiation that was reflected from the first freeform mirror from a second freeform mirror mounted in the imaging spectrometer, the second freeform mirror having positive focal power; reflecting the radiation that was reflected from the second freeform mirror from a third freeform mirror mounted in the imaging spectrometer, the third freeform mirror having negative or positive focal power; reflecting the radiation that was reflected from the third freeform mirror from a fourth freeform mirror mounted in the imaging spectrometer, the fourth freeform mirror having positive focal power; reflecting the radiation that was reflected from the fourth freeform mirror from a fifth freeform mirror mounted in the imaging spectrometer, the fifth freeform mirror having positive focal power; reflecting and spectrally dispersing the radiation that was reflected from the fifth freeform mirror from a spectrally-dispersive optic, the spectrally-dispersive optic mounted in the imaging spectrometer such that the radiation reflected and spectrally dispersed from the spectrally-dispersive optic passes back through the imaging spectrometer sequentially reflecting from the fifth freeform mirror, the fourth freeform mirror, the third freeform mirror, the second freeform mirror, and the first freeform mirror; and imaging, with a detector array, a spectrally-dispersed image formed from the radiation that passed back through the imaging spectrometer and is formed at an image plane of the imaging spectrometer.

All combinations of the foregoing concepts and additional concepts discussed in greater detail below (provided such concepts are not mutually inconsistent) are part of the inventive subject matter disclosed herein. In particular, all combinations of subject matter appearing in this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally and/or structurally similar elements).

FIG. 1 is a simplified depiction of a slit-based imaging spectrometer.

FIG. 2A depicts optical components and optical rays for a five-mirror, all-reflective, imaging spectrometer.

FIG. 2B depicts, in perspective view, optical components and optical rays for a five-mirror, all-reflective, imaging spectrometer.

FIG. 2C depicts optical components and optical rays for an example implementation of a five-mirror, all-reflective, imaging spectrometer.

FIG. 3A depicts an optical arrangement for an f/2 imaging spectrometer of medium size.

FIG. 3B depicts an optical arrangement for an f/3 imaging spectrometer of larger size than the arrangement of FIG. 3A.

FIG. 3C depicts an optical arrangement for an f/2.8 imaging spectrometer of smaller size than the arrangement of FIG. 3A.

FIG. 4 depicts a single optical substrate on which two mirrors of the imaging spectrometer can be formed.

FIG. 5 depicts an example implementation of an imaging spectrometer assembly.

FIG. 6A plots spot size for a five-mirror, all-reflective, imaging spectrometer as a function of slit position and wavelength or spectral position.

FIG. 6B plots keystone error for a five-mirror, all-reflective, imaging spectrometer as a function of slit position and wavelength or spectral position.

FIG. 6C plots smile error for a five-mirror, all-reflective, imaging spectrometer as a function of slit position and wavelength or spectral position.

### DETAILED DESCRIPTION

### 1. Introduction

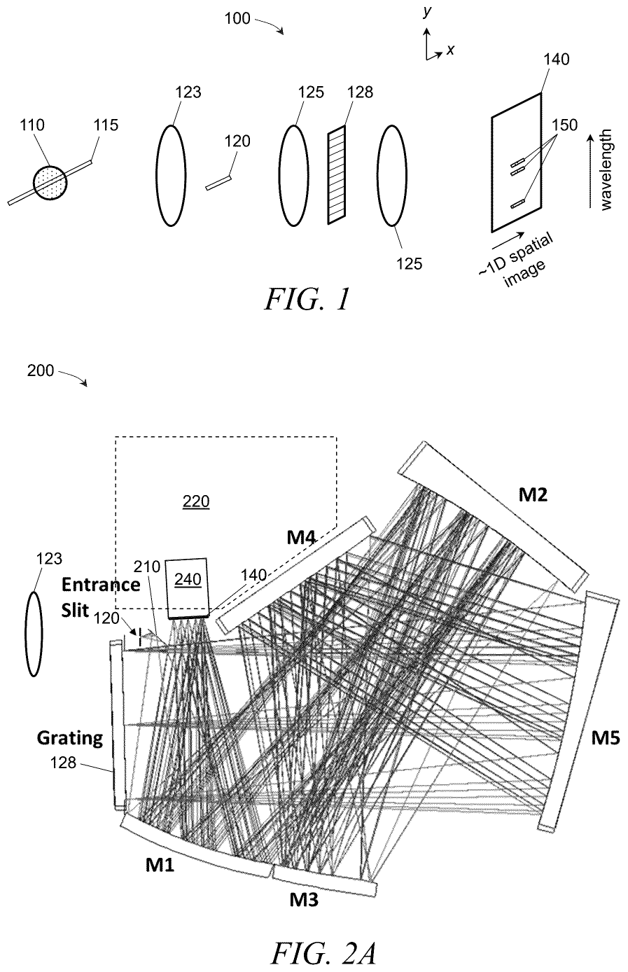

Some imaging spectrometers (also referred to as “spectral imagers”) employ an entrance slit, imaging optics, and a spectrally-dispersive optic to image a strip in the spectrometer's field of view. FIG. 1 is a simplified illustration of such a spectral imaging system 100 depicting the strip-like field of view (FOV) 115. The spectral imaging system 100 comprises an input lensing system 123 (which could be one or more optical elements), an entrance slit 120, an internal lensing system 125 (which could be one or more optical elements), and a spectrally-dispersive optic 128 (e.g., a diffraction grating or prism). Radiation from objects 110 in a field of view of the imaging spectrometer is collected and imaged at the entrance slit 120 by the input lensing system 123. Light passing through the entrance slit 120 is spectrally dispersed by the spectrally-dispersive optic 128 and focused by the internal lensing system 125 (and possibly the spectrally-dispersive optic 128 also) onto an image plane 140 to form one or more strip images 150. Based on wavelengths received (emitted, reflected, or scattered) from the objects 110 (emitted from a round plume in this example), there can be a plurality of strip images 150 spatially dispersed (in the y direction indicated in the drawing) due to the spectrally-dispersive optic 128. The position of each spatially-dispersed strip image 150 corresponds to a different wavelength received from the imaged objects. Stated alternatively, image information is resolved mainly in one dimension at the image plane 140 (the x direction in the illustration, though the strip-like FOV 115 can have some small width in the orthogonal direction) and spectral information is spread out and resolved orthogonally (the y direction) at the image plane 140. A detector array (e.g., a two-dimensional, pixelated CCD or CMOS imager or a focal plane array) can be placed at the image plane 140 to capture spatial and spectral information about the scene viewed by the spectral imaging system 100.

To acquire a larger field of view (in the y direction in the drawing), the spectral imaging system 100 can be moved to sweep over the objects to be imaged, which is referred to as “push broom” or “whisk broom” imaging or scanning. In some cases, spectral imaging systems are mounted on flying aircraft or satellites to obtain spectral and 2D image information about features of interest on the Earth's surface. An image is built up in time, by scanning the 1D FOV of the imaging spectrometer over the area observed, and then stitching the individual 1D strip images together to create a 2D image of the area. The spatial and spectral information form a full 3D data cube, with each spatial element containing a full spectral profile.

The inventor has recognized and appreciated that legacy slit-based imaging spectrometer designs have typically not employed large area, large format detectors (which could improve coverage area or spectral resolution) because doing so would involve a significant increase in size of the spectral imager. A drawback to increased size is that component cost and fabrication complexity increases, in some cases exceeding the capability for manufacture if refractive components are used in the spectrometer.

Another challenge to conventional imaging spectrometers relates to the spectrally-dispersive optic 128. Imaging spectrometers such as the Offner-Chrisp and Dyson spectrometers require the spectrally-dispersive optic to have curvature. Writing high-performance gratings on curved surfaces, especially aspheric surfaces, is difficult, particularly when low scatter and high-efficiency is desired. Additionally, alternate implementations of imaging spectrometers using wedged prisms with curvature on one or both surfaces are difficult to fabricate to the precision suitable for high-resolution spectral imaging. Imaging spectrometers which utilize flat gratings are preferential due to the ease of manufacturing the flat grating and improved quality, especially in high-volume low-cost application spaces.

As detector technology evolves, large-format focal-plane arrays (FPAs) become available for incorporation into spectral imaging systems. These FPAs can maintain a pixel size so that overall system étendue is not reduced, which leads to a larger overall area of the FPA die. To utilize the larger FPAs, the entrance slit 120 can grow in length, increasing the strip-like FOV 115 and swath width of the spectral imager. One approach to increasing slit length is to scale up the size of all optical components in the imaging spectrometer. However, scaling up the size of optical components results in a penalty to overall SWAP. Further, with systems that use refractive optical components, size scaling may not be possible or practical if glass blanks for shaped refractive optics are unavailable or exceedingly expensive over a certain size. Reflective systems may be easier to scale in size as blank production for reflective optics is rarely a limitation. However, existing reflective designs are generally not as compact or fast as their catadioptric counterparts. Additionally, the inventor has recognized and appreciated that aberrations increase non-linearly with FOV size and thus become more difficult to correct over longer entrance slits 120.

The inventor has recognized and appreciated that an effective imaging spectrometer should present a well corrected image to the FPA with consistent spectral dispersion between each column of pixels at the FPA. Most spectrometers are photon starved, especially in higher spectral resolutions, and use a larger pitch to help with increasing the étendue factor of the unit. Thus, an imaging spectrometer with “faster” optics is desirable for collecting more photons than a spectrometer with slower (lower focusing power) optics. A higher collection of photons allows low-f-number systems to either see fainter objects or increase the number of spectral elements over their bandwidth without a penalty to signal-to-noise (SNR). However, faster optics present a greater challenge in terms of controlling optical aberrations including distortion. Preferably, an imaging spectrometer exhibits low optical distortion in the form of keystone distortion or smile distortion. Smile distortion results in different colors being offset in the spectral columns for each spatial element. Keystone distortion causes spectra to shift into adjacent columns tied to different spatial points. Both forms of distortion result in difficulty determining which color ties to which spatial element in high-resolution systems. These distortions also increase challenges to provide accurate spectral calibration over time with changing environmental factors. A typical target for imaging spectrometers is <0.1 pixel of distortion across the entire FPA under operating conditions, which could span a wide range of operating temperatures (e.g., more than 50° C.).

### 2. Five-Mirror Freeform Imaging Spectrometer

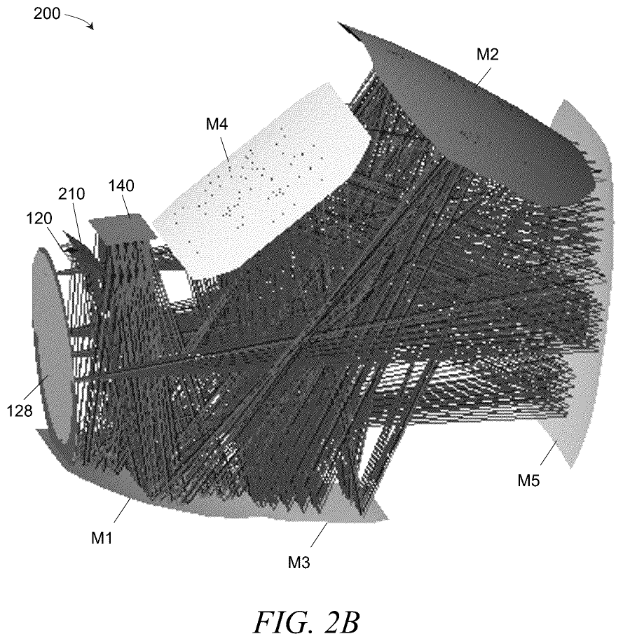

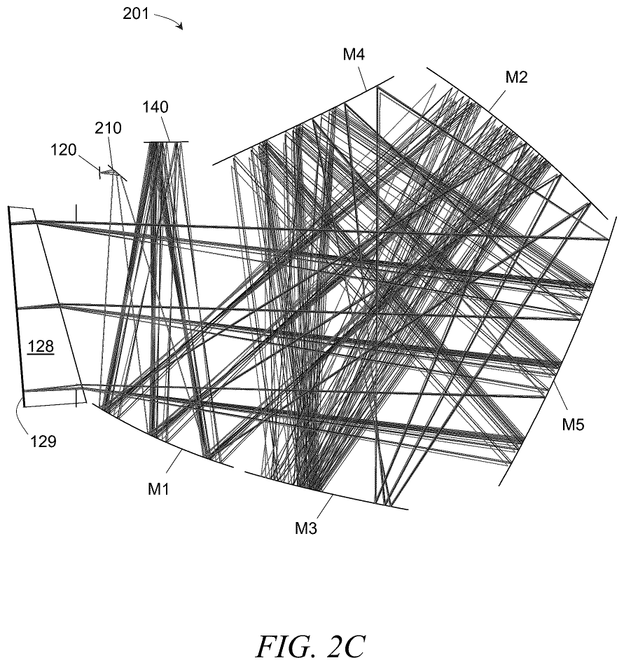

FIG. 2A is a 2D rendering of a five-mirror freeform imaging spectrometer 200. The term “freeform” is used because the five mirrors can have reflective surfaces that do not follow a single polynomial shape (such as spherical, paraboloid) that has rotational symmetry. Instead, the freeform mirror can have a reflective surface described by multiple polynomial terms or numerically solved shapes using control points (e.g., splines), and the function describing the reflective surface does not have rotational symmetry. The five-mirror freeform imaging spectrometer 200 comprises an entrance slit 120, a folding mirror 210, a first freeform mirror M1, a second freeform mirror M2, a third freeform mirror M3, a fourth freeform mirror M4, a fifth freeform mirror M5, and a spectrally-dispersive optic 128 (e.g., a diffraction grating and/or prism). The length of the entrance slit can be from approximately 20 nm to approximately 75 nm. The rendering shows traces of optical rays that traverse five freeform mirrors M1, M2, M3, M4, M5 in a star-like pattern when traveling from the entrance slit 120 to the image plane 140. Incident rays from a field of view, which extends in a direction approximately perpendicular to the drawing plane, pass through the entrance slit 120 and into the imaging spectrometer 200. The folding mirror 210 may or may not be used. When used, the folding mirror 210 can redirect radiation that has passed through the entrance slit 120 and increase the size of a detector volume 220 behind the image plane 140 and mirror M4. The detector volume 220 can accommodate image capture apparatus such as a detector array or FPA. The five-mirror freeform imaging spectrometer 200 can further comprise an image sensor 240 (e.g., a detector array) located at the image plane 140. In some implementations, the five-mirror freeform imaging spectrometer 200 also includes an input lensing system 123 that forms an image of the field of view at the entrance slit 120.

FIG. 2B is a perspective view rendering of the five-mirror freeform imaging spectrometer 200. The drawing generally indicates the shapes of the freeform mirrors. Radiation that has passed through the entrance slit 120 reflects from the five mirrors in the following order on the way to the spectrally-dispersive optic 128: M1, M2, M3, M4, M5. The radiation then reflects from and is spectrally dispersed by the spectrally-dispersive optic 128. The radiation reflected and spectrally dispersed by the spectrally-dispersive optic 128 travels back through the spectrometer, reflecting from the freeform mirrors in the reverse order (M5, M4, M3, M2, M1) to form spectrally-dispersed images at the image plane 140.

The imaging spectrometer 200 comprises an entrance slit 120, at an optical input to the spectrometer and five optically powered mirrors M1, M2, M3, M4, M5 which create a pupil where the spectrally-dispersive optic 128 (a flat reflective diffraction grating in this example) is located. The entrance slit can have a length from approximately or exactly 20 mm to approximately or exactly 60 mm. In some implementations, the entrance slit can have a length from 5 mm to 100 mm, or from 20 mm to 200, though shorter lengths than 5 mm are possible and longer lengths than 200 mm may be possible. The imaging spectrometer 200 is operated in double-pass so that the five mirrors M1, M2, M3, M4, M5 also refocus radiation reflected and spectrally dispersed by the spectrally-dispersive optic 128 (a flat diffraction grating in the illustrated example), forming the spectrally dispersed image at the image plane 140. The image formed at the image plane is spatially separated from the location of the entrance slit 120. The spectrally-dispersive optic 128 is located at a pupil of the imaging spectrometer, so that each image point receives identical spectral dispersing without mixing the spatial dimensions.

The input lensing system 123 can comprise one or more optical elements. The input lensing system 123 can have an f-number (f/ #) at its output that matches or approximately matches the input f-number of the five-mirror freeform imaging spectrometer 200. Preferably, the input lensing system 123 is telecentric such that it produces a telecentric optical input at the entrance slit 120.

Although imaging spectrometers have been designed to use three freeform mirrors, the inventor has recognized and appreciated that these spectrometers have not been able to scale FOV while maintaining a low distortion target. The inventor has recognized and appreciated that using five reflective mirrors can provide enough degrees of freedom for the large dimensionality and performance suitable for a large-area imaging spectrometer. A large-area imaging spectrometer can have slit lengths of 20 mm and longer and use detector arrays suitable for high-definition imaging (e.g., at least 1200 pixels in both dimensions spanning at least 20 mm at the image plane 140).

For the imaging spectrometer 200 depicted in FIG. 2A and FIG. 2B, mirrors M1 and M2 create an aberrated intermediate image plane located along an optical path between mirrors M2 and M4. The aberrated intermediate image plane can be located closer to mirror M3 than it is with respect to either mirror M2 or M4. With the two-mirror configuration of M1 and M2, the optical system can correct astigmatic field aberrations or field curvature (such as Petzval field curvature) for large fields, but not both astigmatic aberrations and field curvature. This results in a curved intermediate image. Mirrors M3, M4, and M5 have the ability to correct the field curvature (e.g., Petzval field curvature) as well as the remaining aberrations prior to the spectrally-dispersive optic 128, so as to present the spectrally-dispersive optic 128 (e.g., reflective grating) with a well corrected and collimated pupil.

FIG. 2C depicts optical components and optical rays for an example implementation of a five-mirror, all-reflective, imaging spectrometer 201. The imaging spectrometer also includes a slit 120 and folding mirror 210. In this implementation, the spectrally-dispersive optic 128 comprises a prism having a reflective surface 129.

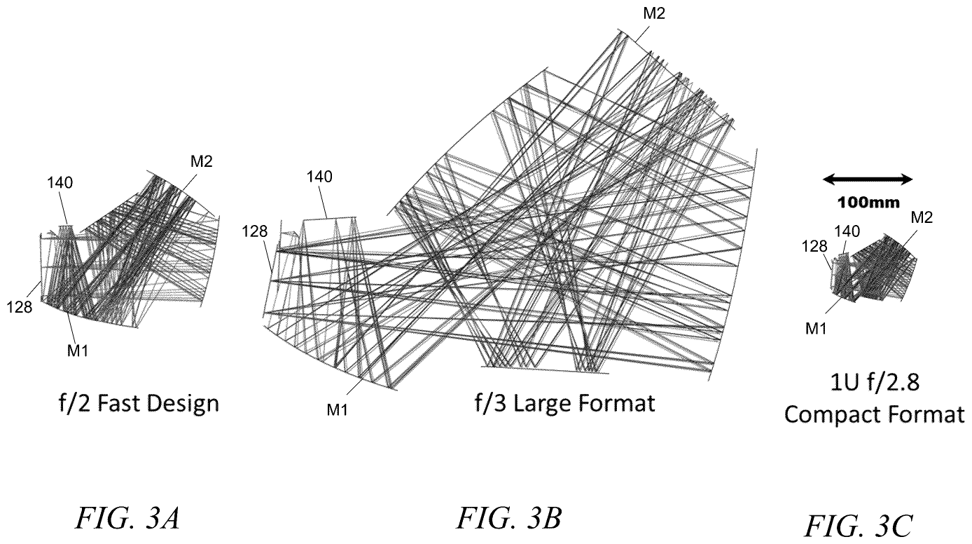

Because of the use of five mirrors, the imaging spectrometer can be implemented in different sizes with different f-numbers. The five-mirror design allows scaling to larger FPAs that may become available while maintaining low distortion errors. Three example and different design configurations are depicted in FIG. 3A, FIG. 3B, and FIG. 3C along with a scale marker for the three configurations. Specifications for the three configurations are listed in Table 1E. A configuration can target increased swath (via slit length), spectral resolution, or SWAP while maintaining sufficient minimum spot size and low distortion for high spatial and spectral resolution. The configuration of FIG. 3A, with a slit length of 28 mm, can be packaged within a 3 U to 5 U standard Cubesat volume (depending on the selected f/ #) and provide very high radiation collection with a fast optical design of approximately f-1.8 to f-2.2. In some cases, an imaging spectrometer 200 having a slit length no larger than 28 mm and an f/ #no greater than 2.2 can fit within a 2 U Cubsat volume. The configuration of FIG. 3B can be used for imaging over larger areas and has an f-number of approximately 3. The configuration of FIG. 3C is very compact, fitting within a 1 U standard Cubesat volume (10 cm×10 cm×10 cm volume) and providing an f-number of approximately 2.8.

TABLE 1
Example Configurations for Five-Mirror
Freeform Imaging Spectrometer

| | Specification | | |
|---|---|---|---|
| | Fast | Large | Compact |
| | Design | Format | Format |
| Parameter | (FIG. 3A) | (FIG. 3B) | (FIG. 3C) |
| f/# | f/2 | f/3 | f/2.8 |
| Slit Length (mm) | 28 | 54 | 25 |
| Spectral Length (mm) | 12.3 | 54 | 10 |
| Target Pixel Pitch (μm) | 18 | 18 | 15 |
| Waveband (nm) | 375-2400 | 1500-2500 | 375-2400 |
| Displacement Volume (cm³) | 3800 | 31350 | 480 |
| Outer Volume (cm³) | 4700 | 48500 | 540 |
| Max RMS Spot Size (μm) | 16 | 10 | 9 |
| Keystone Distortion (μm) | <1.2 | <1.3 | <0.8 |
| Smile Distortion (μm) | <1.4 | <1.1 | <0.4 |

An advantage of an all-reflective design for the imaging spectrometer 200 is wavelength agnosticism because the curved reflective elements do not have color dispersion that occurs with refraction from a transmissive optical element such as a lens. Grating or prism elements can be selected and interchanged based on the desired waveband with mild variations in performance. This simplifies reconfiguration of the unit for different scientific and remote sensing use cases, where the spectral bands and bandwidth can be selected that are suitable for the desired imaging application. Optical throughput is determined by the high-reflector coatings used on the mirrors and spectrally-dispersive optic 128, the number of reflections, and the dispersion efficiency of the grating.

Design of the freeform mirrors for the imaging spectrometer 200 begins on-axis using spherical mirrors and then transforming the spherical mirror surfaces to aspheres to position each of the mirrors within the layout along the chosen fold path and achieve stigmatic spots over the desired spectral dispersion range at the image plane 140. As the field along the slit increases, computer-aided design code converts the surface shapes into non-rotationally symmetric freeform shapes to obtain a desired level of performance along the full slit length. This conversion of surface shapes increases the number of shape modification parameters from approximately 20 terms to 100 s of terms that are adjusted by the computer to obtain the desired level of performance. Commercially-available software (such as Code V optical design software, available from Synopsis, Inc., of Sunnyvale, California) can be used to define and adjust parameters of the freeform surfaces to obtain the desired level of performance.

The design of the imaging spectrometer 200 can be considered an off-axis imaging system that operates in double pass. In the reverse optical path from the spectrally-dispersive optic 128 to the image plane 140, mirror M5 and mirror M4 form a folded imaging telescope of the Yolo form with an accessible entrance pupil located at the spectrally-dispersive optic 128 and forming an aberrated image plane near mirror M3 (between mirror M4 and mirror M2). Mirrors M3, M2, and M1 form an optical relay set that corrects for field curvature (such as Petzval field curvature). These mirrors relay the image at the aberrated image plane and output a telecentric image at the image plane 140. Mirror M2 creates a pupil at a distance of one focal length from mirror M1, and mirror M1 provides the final focusing power onto the image plane 140. Mirror M3 can function as a field-correcting optic, akin to a field lens, which applies a fixed amount of field curvature to correct the inherent Petzval curvature that occurs from two mirror, wide-field systems.

Table 2 gives an example of local curvature values along a central tangential plane passing through the surface of the first mirror M1. The curvature values were obtained using the design process described above and indicate the astigmatic optical focusing characteristic of the mirror's reflective surface at east point along the Y axis of the mirror. For this example, the height of the mirror is approximately 30 mm. The curvature values listed are only examples for one design of mirror M1, and the values will depend upon the wavelengths for which the imaging spectrometer is designed as well as the length of the entrance slit 120 and desired f-number of the imaging spectrometer. Other curvature values can be used in implementations of the imaging spectrometer.

TABLE 2
Example Curvature Values of Freeform Mirror M1

| Tangential | | |
|---|---|---|
| plane | Local sagittal | Local tangential |
| location (mm) | curvature (1/mm) | curvature (1/mm) |
| −14 | −0.00868134 | −0.00105223 |
| −13 | −0.00887271 | −0.0010974 |
| −12 | −0.00905058 | −0.00114487 |
| −11 | −0.00920147 | −0.00119321 |
| −10 | −0.00931798 | −0.00124139 |
| −9 | −0.00939796 | −0.00128872 |
| −8 | −0.00944311 | −0.0013348 |
| −7 | −0.00945761 | −0.00137943 |
| −6 | −0.00944676 | −0.0014225 |
| −5 | −0.00941582 | −0.00146401 |
| −4 | −0.00936933 | −0.00150396 |
| −3 | −0.00931064 | −0.0015424 |
| −2 | −0.00924194 | −0.00157938 |
| −1 | −0.0091645 | −0.001615 |
| 0 | −0.00907912 | −0.00164938 |
| 1 | −0.00898671 | −0.00168275 |
| 2 | −0.00888881 | −0.00171537 |
| 3 | −0.00878796 | −0.0017476 |
| 4 | −0.00868764 | −0.00177984 |
| 5 | −0.00859175 | −0.00181255 |
| 6 | −0.00850326 | −0.00184617 |
| 7 | −0.00842176 | −0.00188098 |
| 8 | −0.0083397 | −0.00191698 |
| 9 | −0.00823702 | −0.00195363 |
| 10 | −0.00807398 | −0.00198942 |
| 11 | −0.00778214 | −0.00202146 |
| 12 | −0.00725371 | −0.00204477 |
| 13 | −0.00632991 | −0.00205154 |
| 14 | −0.0047893 | −0.00203029 |

For the imaging spectrometer, the first mirror M1 and second mirror M2 have positive (converging) focal power. In some implementations, the third mirror M3 has negative focal power. In some implementations, the third mirror M3 can have positive focal power. The fourth mirror M4 and the fifth mirror M5 have positive focal power. This mirror arrangement allows the spectrally-dispersive optic 128 to be a flat (i.e., planar) grating rather than a concave grating, which is used in some conventional imaging spectrometers and is significantly more difficult and expensive to manufacture. The imaging spectrometer 200 can be designed for imaging and spectral detection at wavelength bands within a range of wavelengths from 200 nm to 20000 nm. For example, the imaging spectrometer can be designed to operate in any of the following wavelength ranges: ultraviolet, visible, near infrared (NIR), short wavelength infrared (SWIR), mid-wavelength infrared (MWIR), and long wavelength infrared (LWIR).

In some implementations, the spectrally-dispersive optic 128 is a diffraction grating with a line density that can spread a spectral range (centered about a selected wavelength) of no less than 1000 nm across the image plane 140 and an attached detector array. For higher spectral resolution around the same wavelength, the spectrally-dispersive optic 128 is a diffraction grating with a line density that spreads a spectral range (centered about a selected wavelength) of no greater than 600 nm across the image plane 140 and an attached detector array. In some cases, the spectrally-dispersive optic 128 is a diffraction grating with a line density that spreads a spectral range of no less than 100 nm across the image plane 140 and the attached detector array. For lower spectral resolution and wider spectral range around the same wavelength, the spectrally-dispersive optic 128 is a diffraction grating with a line density that spreads a spectral range of no less than 2000 nm across the image plane 140 and the attached detector array. For the above examples, the selected wavelength could be 4 microns. The amount of spectral spreading across the image plane 140 and detector array 240 could be less for shorter wavelengths and more for longer wavelengths. In some implementations, the spectral spreading across the detector array 240 is from 30% to 70% of the selected wavelength for medium resolution, 0.1% to less than 30% for high resolution, and more than 70% for low resolution. Spreading a smaller range of wavelengths across the detector array 240 provides a finer sampling of the spectral range by the detector array and thus higher resolution data.

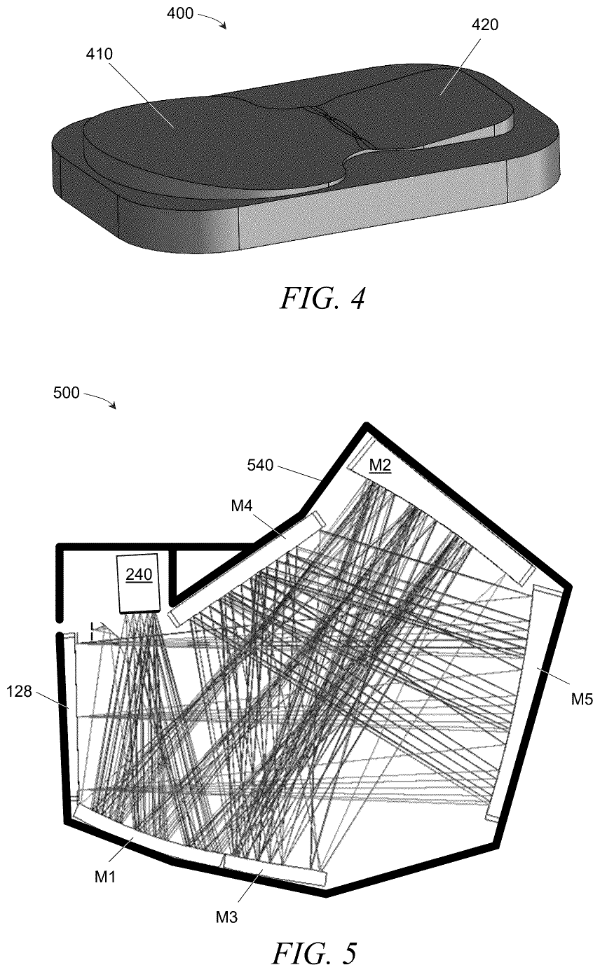

There is some flexibility in the positioning of mirror M3 for the imaging spectrometer 200. This mirror can be located within the space between mirror M1 and mirror M5, below the dispersing rays from the spectrally-dispersive optic 128. In some configurations, such as the fast design of FIG. 3A, mirror M3 can be positioned close enough to mirror M1 that the two reflective surfaces could be formed on a single monolithic substrate with distinct reflective regions for the functionality of mirror M1 and mirror M3. FIG. 4 depicts an implementation of a monolithic substrate 400 on which is formed a first reflective region 410 for mirror M1 and a second reflective region 420 for mirror M3.

### 3. Packaging

FIG. 5 depicts an example of a spectral imager assembly 500 in which the imaging spectrometer 200 is packaged compactly. The mirrors M1, M2, M3, M4, M5, can be formed from a low-thermal-expansion material in some cases, such as aluminum, SiC, or a low thermal expansion glass such as Zerodur®. Other materials may be used in applications where temperature swings are not large, can be controlled, or can be tolerated. A beneficial feature of the five-mirror, freeform imaging spectrometer is that the detector array 240 can reside mostly or entirely within a cutout space (detector volume 220 in FIG. 2A) behind mirror M4, reducing or eliminating the increase in SWAP when attaching the detector array 240. An example detector array that can be used for large area imaging is the Teledyne 3000×3000-pixel Geosnap-18 detector array with cooling. The freeform mirrors M1, M2, M3, M4, M5, folding mirror 210, and spectrally-dispersive optic 128 can mount on adjustable mounts to allow for optical alignment after assembly. The adjustable mounts can be mounted on a base and/or walls of an enclosure 540 that blocks stray light from entering the imaging spectrometer. The enclosure 540 can be formed from a metal or ceramic, such as aluminum, Invar, SiC, or Super Invar. In some implementations, at least one of the freeform mirrors M1, M2, M3, M4, M5, folding mirror 210, and spectrally-dispersive optic 128 can mount directly to the base and/or wall(s) of the enclosure 540 without provision for adjustment after mounting. In some implementations, at least two or more of the freeform mirrors M1, M2, M3, M4, M5 are mechanically coupled to or mount directly to the enclosure 540. The entrance slit 120, freeform mirrors M1, M2, M3, M4, M5, folding mirror 210 (if used), and spectrally-dispersive optic 128 could be arranged in the enclosure 540 as shown in FIG. 5.

### 4. Performance

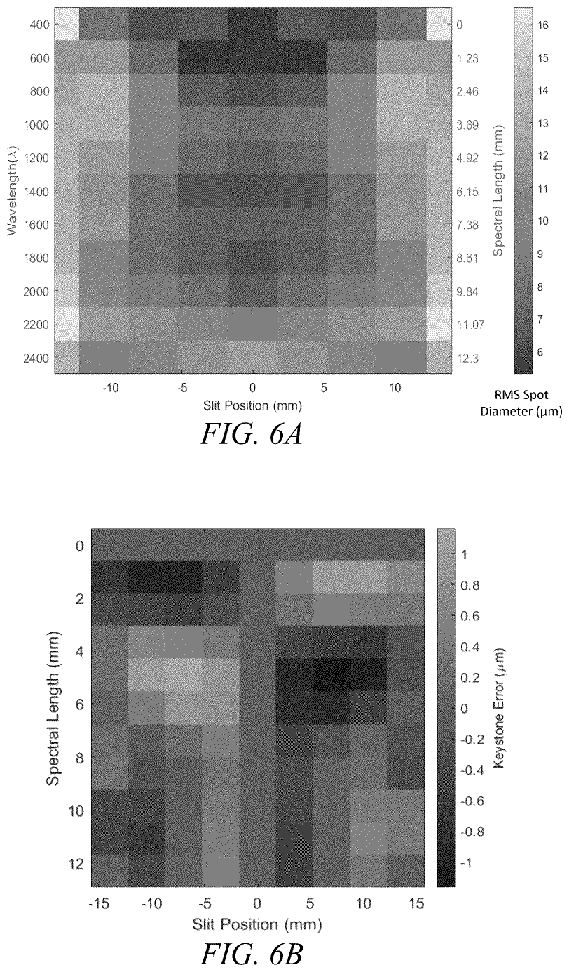

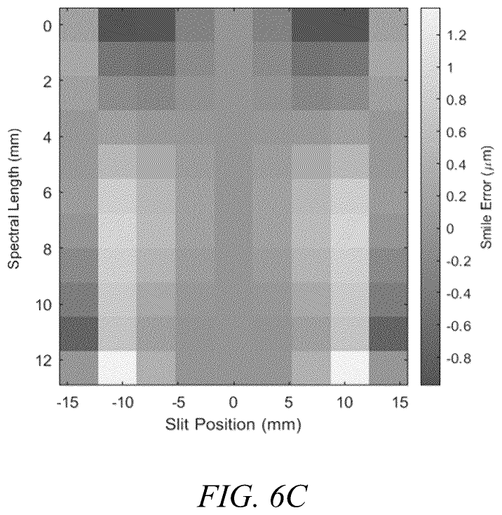

FIG. 6A indicates image resolution for the f/2 imaging spectrometer 200 of FIG. 3A. Minimum spot size for a point source is plotted as a function of point source position along the slit and wavelength or dispersed position in the spectral direction. For this simulation, the grating dispersion was about 2000 nm in the spectral direction. The increase in spot size is less than a factor of 3 at the edges of a 28 mm slit and ends of the spectral range. Since the spectrometer is designed for an 18-micron pixel size, the largest spot size (about 16 microns) in the image plane is less than 1 pixel. This means that spatial information can be well correlated and resolved.

FIG. 6B plots keystone error for the same spectrometer design as a function of point source position along the slit and dispersed position in the spectral direction. The slit length is increased to 32 mm. The keystone error is less than 1/10th pixel over the full slit range and spectral dispersion range.

FIG. 6C plots smile error for the same spectrometer design as a function of point source position along the slit and dispersed position in the spectral direction. The smile error is also less than 1/10th pixel over the full slit range and spectral dispersion range.

### 5. Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

Unless stated otherwise, the terms “approximately” and “about” are used to mean within ±20% of a target (e.g., dimension or orientation) in some embodiments, within ±10% of a target in some embodiments, within ±5% of a target in some embodiments, and yet within ±2% of a target in some embodiments. The terms “approximately” and “about” can include the target. The term “essentially” is used to mean within ±3% of a target.

The indefinite articles “a” and “an,” as used herein, unless clearly indicated to the contrary, should be understood to mean “at least one.”

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” shall have its ordinary meaning as used in the field of patent law.

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An imaging spectrometer comprising:
an entrance slit through which radiation enters the imaging spectrometer;
a first freeform mirror having positive focal power arranged to receive and reflect the radiation that passed through the entrance slit;
a second freeform mirror having positive focal power arranged to receive and reflect the radiation that reflected from the first freeform mirror;
a third freeform mirror having negative or positive focal power arranged to receive and reflect the radiation that reflected from the second freeform mirror;
a fourth freeform mirror having positive focal power arranged to receive and reflect the radiation that reflected from the third freeform mirror;
a fifth freeform mirror having positive focal power arranged to receive and reflect the radiation that reflected from the fourth freeform mirror;
a spectrally-dispersive optic arranged to receive, reflect and spectrally disperse the radiation that reflected from the fifth freeform mirror, where radiation reflected from the spectrally-dispersive optic passes back through the imaging spectrometer sequentially reflecting from the fifth freeform mirror, the fourth freeform mirror, the third freeform mirror, the second freeform mirror, and the first freeform mirror; and
a detector array arranged to receive the radiation that passed back through the imaging spectrometer and reflected from the first freeform mirror.

2. The imaging spectrometer of claim 1, wherein the first freeform mirror and the third freeform mirror are formed on a same, single, integrated substrate.

3. The imaging spectrometer of claim 1, further comprising an enclosure to which at least two freeform mirrors of the first, second, third, fourth, and fifth freeform mirrors are mechanically coupled.

4. The imaging spectrometer of claim 3, wherein the first, second, third, fourth, and fifth freeform mirrors are arranged around the enclosure such that:
the second freeform mirror is located between the fourth freeform mirror and the fifth freeform mirror; and
the third freeform mirror is located between the first freeform mirror and the fifth freeform mirror.

5. The imaging spectrometer of claim 4, wherein:
the entrance slit is mechanically coupled to the enclosure between the spectrally-dispersive optic and the fourth freeform mirror; and
the detector array is mechanically coupled to the enclosure between the entrance slit and the fourth freeform mirror.

6. The imaging spectrometer of claim 3, having an f-number no larger than 2.2, a slit length no longer than 28 mm, and sized to fit within two standard Cubesat units, wherein one standard Cubesat unit measures 10 cm×10 cm×10 cm.

7. The imaging spectrometer of claim 3, wherein the entrance slit has a length from 20 mm to 75 mm.

8. The imaging spectrometer of claim 1, wherein the spectrally-dispersive optic is a diffraction grating.

9. The imaging spectrometer of claim 8, wherein the spectrally-dispersive optic is configured to spread a spectral range of no less than 1000 nm across the detector array.

10. The imaging spectrometer of claim 8, wherein the spectrally-dispersive optic is configured to spread a spectral range of no greater than 600 nm across the detector array.

11. The imaging spectrometer of claim 1, wherein the spectrally-dispersive optic comprises a prism.

12. The imaging spectrometer of claim 1, further comprising a folding mirror arranged to redirect the radiation that passed through the entrance slit to the first freeform mirror.

13. The imaging spectrometer of claim 1, wherein the first freeform mirror and the second freeform mirror form an aberrated intermediate image plane located along an optical path between the second freeform mirror and the fourth freeform mirror, wherein the aberrated intermediate image plane is located along the optical path closer to the third freeform mirror than to either the second freeform mirror or the fourth freeform mirror.

14. The imaging spectrometer of claim 1, wherein the third freeform mirror, the fourth freeform mirror, and the fifth freeform mirror are configured to correct field curvature prior to the spectrally-dispersive optic.

15. A method of forming a spectrally-dispersed image, the method comprising:
receiving radiation through an entrance slit of an imaging spectrometer;
reflecting the radiation that passed through the entrance slit from a first freeform mirror mounted in the imaging spectrometer, the first freeform mirror having positive focal power;
reflecting the radiation that was reflected from the first freeform mirror from a second freeform mirror mounted in the imaging spectrometer, the second freeform mirror having positive focal power;
reflecting the radiation that was reflected from the second freeform mirror from a third freeform mirror mounted in the imaging spectrometer, the third freeform mirror having negative or positive focal power;
reflecting the radiation that was reflected from the third freeform mirror from a fourth freeform mirror mounted in the imaging spectrometer, the fourth freeform mirror having positive focal power;
reflecting the radiation that was reflected from the fourth freeform mirror from a fifth freeform mirror mounted in the imaging spectrometer, the fifth freeform mirror having positive focal power;
reflecting and spectrally dispersing the radiation that was reflected from the fifth freeform mirror from a spectrally-dispersive optic, the spectrally-dispersive optic mounted in the imaging spectrometer such that the radiation reflected and spectrally dispersed from the spectrally-dispersive optic passes back through the imaging spectrometer sequentially reflecting from the fifth freeform mirror, the fourth freeform mirror, the third freeform mirror, the second freeform mirror, and the first freeform mirror; and
imaging, with a detector array, a spectrally-dispersed image formed from the radiation that passed back through the imaging spectrometer and is formed at an image plane of the imaging spectrometer.

16. The method of claim 15, wherein the imaging spectrometer has an f-number no greater than 2.8.

17. The method of claim 15, wherein the spectrally-dispersive optic is a flat, reflective diffraction grating.

18. The method of claim 15, further comprising:
forming an intermediate aberrated image plane between the second freeform mirror and the third freeform mirror with the radiation reflected from the first freeform mirror and the second freeform mirror before the radiation reaches the third freeform mirror.

19. The method of claim 18, further comprising:
correcting field curvature prior to the spectrally-dispersive optic with the third freeform mirror, the fourth freeform mirror, and the fifth freeform mirror.

20. The method of claim 15, wherein a length of the entrance slit is from 20 mm to 75 mm.
